(19) United States
(12) Patent Application Publication
(10) Pub. No.: US 2020/0033642 A1
(43) Pub. Date: Jan. 30, 2020

(54) OPTICAL TRANSMITTER AND OPTICAL TRANSMISSION METHOD

(71) Applicant: NEC Corporation, Minato-ku, Tokyo (JP)

(72) Inventor: Hirokazu KOMATSU, Tokyo (JP)

(73) Assignee: NEC Corporation, Minato-ku, Tokyo (JP)

(21) Appl. No.: 16/493,363

(22) PCT Filed: Mar. 15, 2018
(86) PCT No.: PCT/JP2018/010183

§ 371 Date: Sep. 12, 2019

(30) Foreign Application Priority Data
Mar. 28, 2017 (JP) 2017-063183

(51) Int. Cl. G02F 1/01; H04B 10/54; H04B 10/58

(52) U.S. Cl. CPC G02F 1/0123; H04B 10/58; H04B 10/54

(57) ABSTRACT

To clarify the characteristics of an optical modulator having output asymmetry due to a non-linear effect, an optical transmitter includes: a light source which outputs light of a predetermined wavelength; a modulator which modulates the light output from the light source using a modulation signal; a modulator drive unit which outputs a modulation signal to the modulator; a control unit which outputs a low-frequency signal to the modulator and a modulator driver, amplitude-modulates the modulation signal using the low-frequency signal, intensity-modulates the amplitude-modulated modulation signal using the low-frequency signal, and receives a monitor signal including a low-frequency signal component; and a detection unit which extracts a low-frequency component of an optical signal output from the modulator, and outputs the low-frequency component as a monitor signal.

### TECHNICAL FIELD

The present invention relates to an optical transmitter and an optical transmission method, and more particularly, to an optical transmitter including an optical modulator and an optical transmission method.

### BACKGROUND ART

As optical modulators used in optical transceivers and optical transmitters, lithium niobate (LN) modulators have been used. However, in recent years, low power consumption and miniaturization are required in optical transceivers. For example, a small-size pluggable optical transceiver such as a C form factor pluggable (CFP) 2 and a CFP 4 has been standardized. Therefore, the miniaturization of the optical modulator is required.

In addition to the miniaturization of the optical transceiver, in order to increase the transmission capacity thereof, it is required to improve frequency utilization efficiency by multilevel modulation such as QPSK, DP-8QAM and DP-16QAM or spectral narrowing using a Nyquist filter. The QPSK is an abbreviation for Quadrature Phase Shift Keying, and the DP-8QAM is an abbreviation for Dual Polarization-8 Quadrature Amplitude Modulation. From this background, a high performance modulator and a modulation control method are required in order to achieve an increase in a transmission capacity and high quality transmission characteristics.

In relation to the present invention, PTL 1 discloses a method for optimizing the driving amplitude of an optical modulator. According to the technology of PTL 1, an optimal value of a modulation degree is obtained by superimposing a low-frequency signal (a dither signal) on a modulation signal inputted to the optical modulator and monitoring a dither signal appearing on the optical output of the optical modulator.

### CITATION LIST

### Patent Literature

[PTL 1] Japanese Unexamined Patent Application Publication No. 2011-232553 A

### SUMMARY OF INVENTION

### Technical Problem

As a small-size optical modulator, there has been known a Mach-Zehnder type semiconductor optical modulator using indium phosphide or silicon as a material. In comparison with the LN optical modulator, the semiconductor optical modulator may have a high non-linearity of input/output characteristics (transfer characteristics) due to an electric field absorption effect peculiar to a semiconductor. When the transfer characteristics are nonlinear, modulation output of the optical modulator with respect to a driving amplitude is asymmetrical between a positive phase modulation direction and a negative phase modulation direction. Due to the influence of the asymmetry, it is difficult to specify optimal operation point (bias) and driving amplitude of the optical modulator even though the method disclosed in PTL 1 is used, resulting in the deterioration of transmission characteristics. On the other hand, it is possible to ensure the linearity of the transfer characteristics by limiting the range of the driving amplitude of the optical modulator. However, when the driving amplitude of the optical modulator is lowered, the amplitude of output light of the optical modulator is reduced, resulting in a reduction of optical output power. Accordingly, in order to drive the semiconductor optical modulator in optimal conditions, it is necessary to clarify the transfer characteristics of the optical modulator.

### OBJECT OF INVENTION

An object of the present invention is to clarify the characteristics of an optical modulator having output asymmetry due to a nonlinear effect.

### Solution to Problem

An optical transmitter of the present invention comprises: a light source for outputting light of a predetermined wavelength; a modulator for modulating the light outputted from the light source by a modulation signal;

modulator drive means for outputting the modulation signal to the modulator; control means for outputting a low-frequency signal to the modulator and the modulator drive means, amplitude-modulating the modulation signal with the low-frequency signal, intensity-modulating the amplitude-modulated modulation signal with the low-frequency signal, and receiving a monitor signal including a component of the low-frequency signal; and detection means for extracting a low-frequency component of an optical signal outputted from the modulator and outputting the extracted low-frequency component as the monitor signal.

An optical transmission method of the present invention comprises the steps of: outputting light of a predetermined wavelength; modulating, by a modulator, the light outputted from the light source by a modulation signal; outputting the modulation signal to the modulator; amplitude-modulating the modulation signal with the low-frequency signal; intensity-modulating the amplitude-modulated modulation signal with the low-frequency signal; outputting, as a monitor signal, a low-frequency component of an optical signal outputted from the modulator; and detecting transfer characteristics of the modulator, based on the monitor signal.

### Advantageous Effects of Invention

According to the present invention, it is possible to clarify the characteristics of an optical modulator having output asymmetry due to nonlinear effect.

### BRIEF DESCRIPTION OF DRAWINGS

FIG. 1 is a block diagram illustrating a configuration example of an optical transmitter 100 of a first example embodiment.

FIG. 2 is a first diagram for explaining an example of a modulation operation of a modulator 102.

FIG. 3 is a second diagram for explaining the example of the modulation operation of the modulator 102.

FIG. 4 is a third diagram for explaining the example of the modulation operation of the modulator 102.

FIG. 5 is a flowchart illustrating an example of an operation procedure of an optical transmitter 100.

FIG. 6 is a diagram for explaining the example of the modulation operation of the modulator 102 in a third example embodiment.

FIG. 7 is a block diagram illustrating a configuration example of an optical transmitter 200 of a fourth example embodiment.

FIG. 8 is a block diagram illustrating a configuration example of an optical transmitter 300 of a fifth example embodiment.

FIG. 9 is a block diagram illustrating a configuration example of an optical transmitter 400 of a sixth example embodiment.

### EXAMPLE EMBODIMENT

### First Example Embodiment

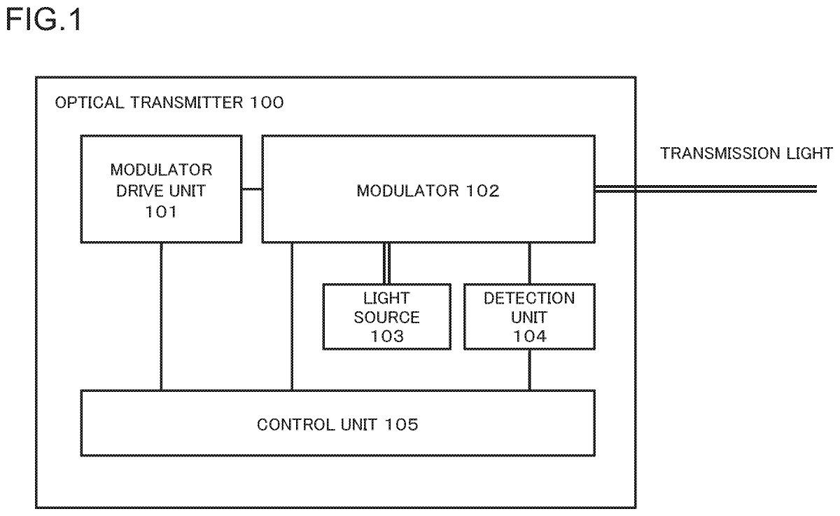

FIG. 1 is a block diagram illustrating a configuration example of an optical transmitter 100 of a first example embodiment of the present invention. In the following example embodiment and drawings, an “optical modulator” is simply referred to as a “modulator”. The optical transmitter 100 includes a modulator drive unit 101, a modulator 102, a light source 103, a detection unit 104, and a control unit 105. The modulator drive unit 101 serves as a modulator drive means that outputs a modulation signal to the modulator 102. The detection unit 104 serves as a detection means that extracts a low-frequency component of an optical signal outputted from the modulator 102. The control unit 105 serves as a control means that controls the modulation signal.

The light source 103 outputs continuous light of a predetermined wavelength. The modulator drive unit 101 outputs the modulation signal to the modulator 102. The control unit 105 modulates an amplitude of the modulation signal in the modulator drive unit 101 by a low-frequency signal having a frequency lower than that of the modulation signal. Moreover, the control unit 105 intensity-modulates the amplitude-modulated modulation signal in the modulator drive unit 101 by using the low-frequency signal in the modulator 102. The amplitude-modulated and intensity-modulated modulation signal is used to modulate the output light of the light source 103 inputted to the modulator 102.

The modulator 102 modulates the output light of the light source 103 and outputs the modulated light (transmission light). The control unit 105 receives the low-frequency signal (monitor signal) extracted in the detection unit 104.

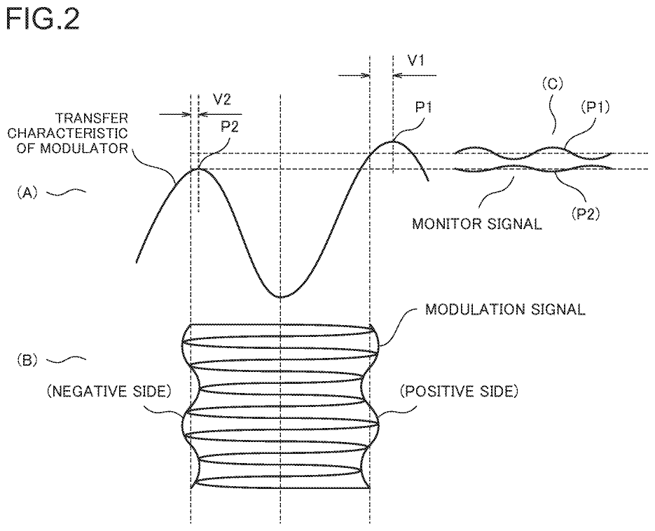

An operation example of the optical transmitter 100 will be described below. FIG. 2 is a first diagram for explaining an example of the modulation operation of the modulator 102. FIG. 2 illustrates an example of the modulation operation of the modulator 102 when the low-frequency signal is inputted only to the modulator drive unit 101 from the control unit 105. That is, FIG. 2 illustrates a case where the modulation signal is subjected to amplitude modulation in the modulator drive unit 101, but is not subjected to intensity modulation in the modulator 102.

The sinusoidal curve (A) of FIG. 2 indicates the transfer characteristics of the modulator 102. In the transfer characteristics, a horizontal axis denotes a driving voltage of the modulator 102 and a vertical axis denotes optical output power of the modulator 102. As indicated by the curve (A), the height of the left peak (P2) and the right peak (P1) of the transfer characteristics of the modulator 102, which indicate the output power of the modulator 102, is asymmetric. This asymmetry is due to the non-linearity of material properties of the modulator 102. As described above, the height of the peak of the transfer characteristics of the modulator 102 may be different for each peak.

The waveform (B) in the lower part of FIG. 2 indicates the modulation signal inputted to the modulator 102 and its envelope. In the waveform (B), a horizontal axis denotes a voltage of the modulation signal and a vertical axis denotes time. The modulator drive unit 101 outputs the modulation signal amplitude-modulated by the low-frequency signal. As indicated by the curve (B) of FIG. 2, the variation amounts of the right and left amplitudes of the envelope of the amplitude-modulated modulation signal are the same and are opposite in phase.

The waveform (C) of FIG. 2 indicates the waveforms of respective peaks of low-frequency signal components corresponding to peaks P1 and P2 of the transfer characteristics, which are included in a monitor signal. The monitor signal (P1) is a monitor signal for the peak P1 and the monitor signal (P2) is a monitor signal for the peak P2. The amplitudes of these signals are minimized when the center of the amplitude of the modulation signal coincides with the peak of the transfer characteristics.

In the waveform (B) of FIG. 2, a voltage difference (position deviation in the right and left direction) V1 between the voltage of the center of the envelope (hereinafter, referred to as “envelope on a positive side”) of the modulation signal corresponding to the peak P1 and the peak P1 is larger than a voltage difference V2 between the voltage of the center of the envelope (hereinafter, referred to as “envelope on a negative side”) corresponding to the left peak P2 and the peak P2. In the vicinity of the center of the amplitude of the envelope on the positive side, since the slope of the transfer characteristics is large compared to the vicinity of the center of the amplitude of the envelope on the negative side, the amplitude of the monitor signal (P1) is larger than that of the monitor signal (P2).

However, actually, the monitor signal (P1) and the monitor signal (P2) indicated by the waveform (C) of FIG. 2 overlap the monitor signal outputted from the detection unit 104. Therefore, only when the modulation signal is amplitude-modulated with the low-frequency signal, it is not possible to know the transfer characteristics (that is, a relation between the driving voltage and the output power) of the modulator 102 for each peak from the low-frequency signal included in the monitor signal.

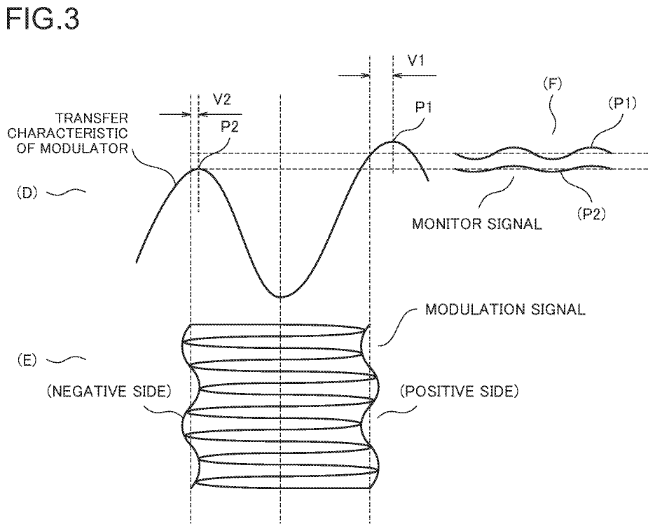

FIG. 3 is a second diagram for explaining an example of the modulation operation of the modulator 102. In FIG. 3, the modulation signal is not subjected to the amplitude modulation of FIG. 2 by the low-frequency signal in the modulator drive unit 101 and is subjected to the intensity modulation by the low-frequency signal in the modulator 102. That is, the control unit 105 intensity-modulates the modulation signal inputted to the modulator 102 with the low-frequency signal. The central sinusoidal curve (D) of FIG. 3 indicates the transfer characteristics of the modulator 102, similarly to FIG. 2.

The control unit 105 intensity-modulates the modulation signal with the low-frequency signal in the modulator 102. That is, as indicated by the waveform (E) in the lower part of FIG. 3, differently from FIG. 2, the modulation signal has a constant amplitude and its envelope is modulated by the low-frequency signal. That is, the waveform on the positive side and the waveform on the negative side of the envelope vary with the same phase.

The waveform (F) of FIG. 3 indicates an example of the waveform of the monitor signal. In the waveform (E) of FIG. 3, the phase of the waveform of the envelope on the positive side is inverted compared to the waveform (B) of FIG. 2. Therefore, the waveform (monitor signal (P1)) of a low-frequency component corresponding to the positive envelope on the positive side is also opposite in phase to the waveform (C) of FIG. 2.

However, also in the case of FIG. 3, the monitor signal (P1) and the monitor signal (P2) indicated by the waveform (F) of FIG. 3 overlap the monitor signal outputted from the detection unit 104. Therefore, even when the modulation signal is intensity-modulated with the low-frequency signal as illustrated in FIG. 3, it is not possible to know the transfer characteristics of the modulator 102 for each peak from the low-frequency signal included in the monitor signal, similarly to FIG. 2.

In this regard, in the present example embodiment, the control unit 105 amplitude-modulates the modulation signal outputted from the modulator drive unit 101 with the low-frequency signal, and further intensity-modulates the amplitude-modulated modulation signal with the low-frequency signal. That is, the control unit 105 outputs the low-frequency signal to both the modulator drive unit 101 and the modulator 102. In such a case, the envelope of the modulation signal for modulating the output light of the light source 103 in the modulator 102 has a form in which the envelope of the modulation signal of FIG. 2 and FIG. 3 is superimposed.

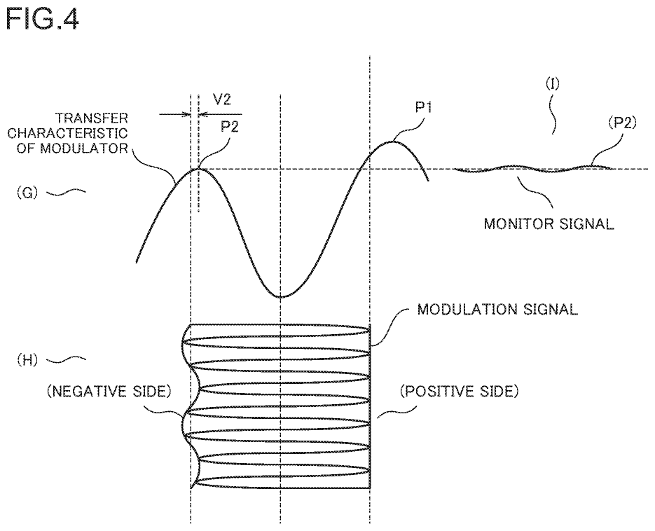

FIG. 4 is a third diagram for explaining an example of the modulation operation of the modulator 102. FIG. 4 illustrates an example of the waveform of the modulation signal in the modulator 102 when the control unit 105 outputs the low-frequency signal to both the modulator drive unit 101 and the modulator 102. The modulation signal is amplitude-modulated in the modulator drive unit 101 and is intensity-modulated in the modulator 102. The curve (G) of FIG. 4 indicates the transfer characteristics of the modulator 102 similar to those of FIG. 2 and FIG. 3.

In FIG. 4, the envelope on the positive side of the modulation signal generated by the low-frequency signal in the modulator drive unit 101 is canceled by the low-frequency signal inputted to the modulator 102. As a consequence, an envelope by the low-frequency signal is generated only on the negative side of the modulation signal (waveform (H) of FIG. 4). As a consequence, the detection unit 104 outputs only the monitor signal (P2) corresponding to the envelope on the negative side on which the low-frequency signal is superimposed (waveform (I) of FIG. 4). The monitor signal indicates the transfer characteristics of the modulator 102 on the peak P2 side. Based on the monitor signal, the control unit 105 can set the driving voltage of the modulator 102 on the peak P2 side.

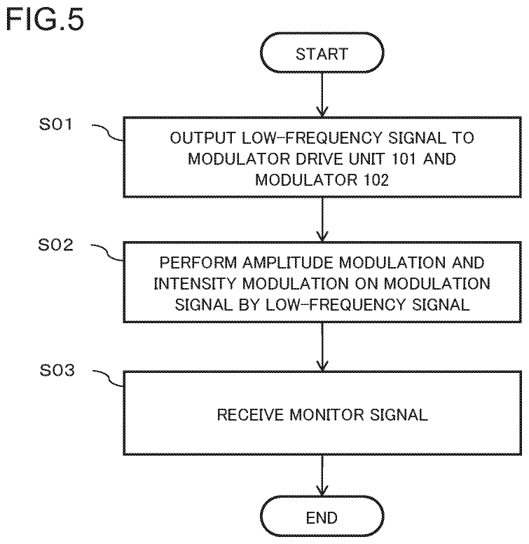

FIG. 5 is a flowchart illustrating an example of an operation procedure of the control unit 105 in the first example embodiment. The control unit 105 outputs the low-frequency signal to the modulator drive unit 101 and the modulator 102 (step S01). The control unit 105 causes the modulator drive unit 101 and the modulator 102 to perform amplitude modulation and intensity modulation on the modulation signal (step S02). The control unit 105 receives a monitor signal having only a low-frequency component of an electrical signal outputted from the modulator 102 (step S03).

As described above, the optical transmitter 100 of the first example embodiment having such a configuration can clarify the characteristics of the modulator having output asymmetry due to a nonlinear effect.

### Second Example Embodiment

With reference to FIG. 1 and FIG. 4, a second example embodiment will be described. As described in the first example embodiment, the detection unit 104 filters the electrical signal outputted from the modulator 102 and outputs a signal of a frequency of the low-frequency signal inputted to the modulator drive unit 101 and the modulator 102 to the control unit 105 as a monitor signal. In the second example embodiment, based on the monitor signal received from the detection unit 104, the control unit 105 sets driving conditions of the modulator 102. The driving conditions of the modulator 102 can be set by a bias voltage applied to the modulator 102, a driving amplitude of a modulation signal, and predistortion. The predistortion means an operation of operating the modulator 102 by using a modulation signal that has been distorted such that the asymmetry of the output light of the modulator 102 is reduced.

The modulator 102 can be driven in conditions considering the transfer characteristics of the modulator 102 by setting the driving conditions more preferably, in such a way that high output and high quality transmission characteristics are achieved. The bias voltage of the modulation signal, the driving amplitude of the modulation signal, and the predistortion are controlled when the control unit 105 controls the modulator drive unit 101 or the modulator 102. For example, the control unit 105 can improve the operation conditions of the modulator in the peak P2 by controlling the amplitudes of the bias voltage and the modulation signal such that the amplitude of the monitor signal (P2) is minimized in FIG. 4. For example, the control unit 105 can set the half value of the amplitude of the modulation signal, which allows the amplitude of the monitor signal to be minimum, to be a driving voltage on the negative side of the modulator 102. The modulator 102 may also control the bias voltage by an instruction of the control unit 105. The modulator drive unit 101 may also control the amplitude of the modulation signal by an instruction of the control unit 105. The modulator 102 can be driven with a larger amplitude by improving the driving conditions of the modulator 102, in such a way that high output and high quality transmission characteristics are achieved in the optical transmitter 100.

Note that the driving conditions of the modulator 102 may be set during the operation of the optical transmitter 100 in response to changes in characteristics of the optical transmitter 100 required by a system. The setting of the driving conditions may be triggered by detecting of changes with time in the transfer characteristics of the modulator 102, path switching on a system side, or the like.

As described above, in the second example embodiment, it is possible to optimize a driving signal by observing the characteristics of the modulator, in such a way that it is possible to prevent the degradation of a signal quality. That is, according to the configuration of the second example embodiment, it is possible to provide an optical transmitter capable of clarifying the characteristics of the modulator having output asymmetry due to a nonlinear effect and achieving high output and high quality transmission characteristics.

### Third Example Embodiment

In FIG. 4 of the first example embodiment, the case where the low-frequency signal is superimposed only on the envelope on the negative side of the modulation signal in order to output only the transfer characteristics on the peak P2 side has been described. However, the phase difference of the low-frequency signal outputted to the modulator drive unit 101 and the modulator 102 is set to 0° or 180° in the control unit 105, in such a way that it is possible to superimpose the low-frequency signal only on one of the envelopes on the positive side and the negative side. That is, the control unit 105 can superimpose the low-frequency signal only on the envelope on the positive side by adjusting the phase difference of the low-frequency signal.

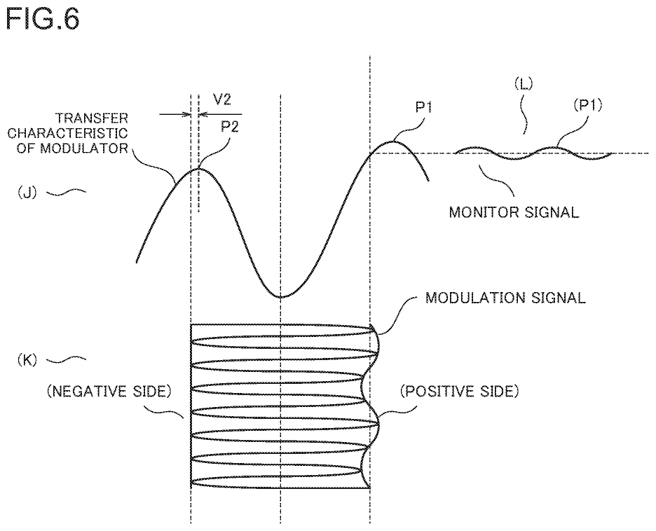

The third example embodiment will be described with reference to FIG. 1 and FIG. 6. FIG. 6 is a diagram for explaining an example of the modulation operation of the modulator 102 in the third example embodiment. Differently from FIG. 4, FIG. 6 illustrates an example in which the low-frequency signal is superimposed only on the envelope on the positive side of the modulation signal. The curve (J) of FIG. 6 indicates the transfer characteristics of the modulator 102 similarly to FIG. 2 to FIG. 4. The control unit 105 inputs the low-frequency signal to the modulator drive unit 101 and the modulator 102 such that only the envelope of the low-frequency signal on the negative side of the modulation signal is cancelled, in such a way that the envelope of the low-frequency signal is generated only on the positive side (waveform (K) of FIG. 6). In such a case, the control unit 105 reverses the phase difference of the low-frequency signal to be outputted to the modulator drive unit 101 and the modulator 102 from that of FIG. 4, and adjusts the amplitude of the low-frequency signal such that the low-frequency signal component of the envelope on the negative side is cancelled in the modulator 102. As a consequence, the detection unit 104 outputs only the monitor signal (P1) corresponding to the envelope on the positive side on which the low-frequency signal is superimposed (waveform (L) of FIG. 6).

Accordingly, first, as described in FIG. 4, the control unit 105 adjusts the phase of the low-frequency signal such that the low-frequency signal is superimposed only on the envelope the negative side of the modulation signal. As a consequence, based on the monitor signal (P2), the control unit 105 can detect the transfer characteristics of the peak P2. Next, as described in FIG. 6, the control unit 105 reverses the phase of the low-frequency signal to be applied to the modulator 102 such that the low-frequency signal is superimposed only on the envelope on the positive side of the modulation signal. Then, based on the monitor signal (P1), the control unit 105 can detect the transfer characteristics of the peak P1. In this way, the control unit 105 can detect the transfer characteristics of both the peaks P1 and P2. The control unit 105 may obtain the half value of the amplitude of the modulation signal for minimizing the amplitude of the monitor signal with respect to each of the peaks P1 and P2, and set the driving voltage of the modulator 102 for each peak, based on the obtained amplitude. Note that the control unit 105 may also reverse the phase of the low-frequency signal to be applied to the modulator drive unit 101, instead of reversing the phase of the low-frequency signal to be applied to the modulator 102.

Also in the configuration of the third example embodiment, similarly to the second example embodiment, it is possible to optimize a driving signal by observing the characteristics of the modulator having output asymmetry due to a nonlinear effect, in such a way that it is possible to prevent the degradation of a signal quality. Moreover, according to the third example embodiment, the control unit 105 can obtain transfer characteristics corresponding to each of the peaks P1 and P2, in such a way that it is possible to further improve the driving conditions of the modulator 102, compared to the case of detecting transfer characteristics of only one peak.

### Fourth Example Embodiment

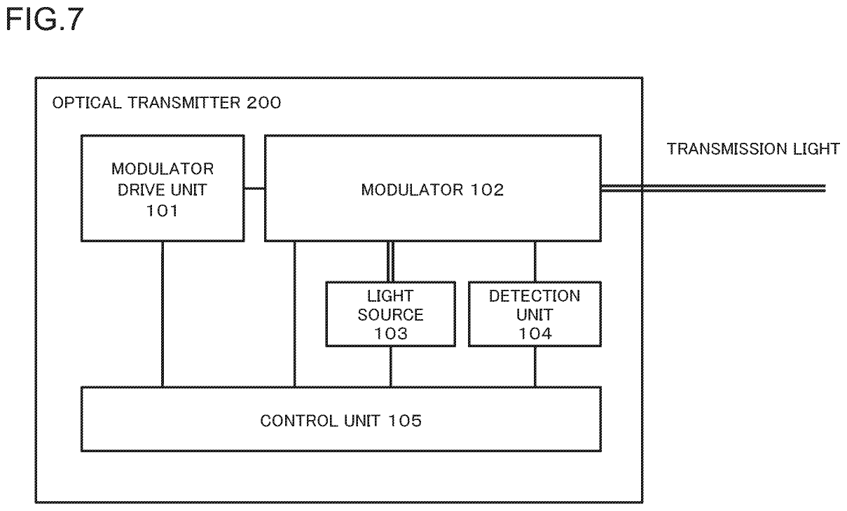

FIG. 7 is a block diagram illustrating a configuration example of an optical transmitter 200 of a fourth example embodiment. The optical transmitter 200 is different from the optical transmitter 100 illustrated in FIG. 1 in that the control unit 105 further has a function of controlling the wavelength of the light source 103. For example, the light source 103 is a wavelength variable laser capable of setting a wavelength by external control. When the wavelength of the light source 103 is changed, the control unit 105 detects the transfer characteristics of the modulator 102 by the procedures described in the first to third example embodiments and sets the driving conditions of the modulator 102 based on the detected transfer characteristics. With such a configuration, even when the wavelength of the light source 103 is changed, the optical transmitter 200 of the fourth example embodiment can clarify the transmission characteristics of the modulator, which has output asymmetry due to a nonlinear effect, for each wavelength. Furthermore, the optical transmitter 200 can drive the modulator 102 in optimal conditions for each wavelength. Note that in the following drawing and description, the elements already described are denoted by the same reference numerals and redundant description is omitted.

Note that the control unit 105 may further have a function of controlling the output power of the light source 103. Whenever the output power of the light source 103 is changed, the control unit 105 may detect the transfer characteristics of the modulator 102 by any one of the procedures described in the first to third example embodiments and set the driving conditions of the modulator 102 based on the detected transfer characteristics.

Moreover, the control unit 105 may also include a lookup table describing predictive values of changes with time of the characteristics of the modulator 102 and a timer. When a predetermined time set in the timer elapses, the control unit 105 may read the predictive values of the characteristics of the modulator 102 corresponding to the elapsed time by referring to the lookup table, and set the driving conditions of the modulator 102 based on the predictive values. The lookup table may include the predictive values of changes with time of the transfer characteristics of the modulator 102 that correspond to wavelengths or output power that can be set in the light source 103.

Similarly to the second and third example embodiments, according to the optical transmitter 200 of the fourth example embodiment, it is also possible to optimize a driving signal by observing the characteristics of the modulator having output asymmetry due to a nonlinear effect, in such a way that it is possible to prevent the degradation of a signal quality. Moreover, even when the wavelength or output power of the light source 103 is switched, the optical transmitter 200 of the fourth example embodiment can detect the output characteristics of the modulator 102 after the switching and operate in optimal modulation conditions. Furthermore, it is also possible to compensate for changes with time of the transfer characteristics of the modulator 102.

### Fifth Example Embodiment

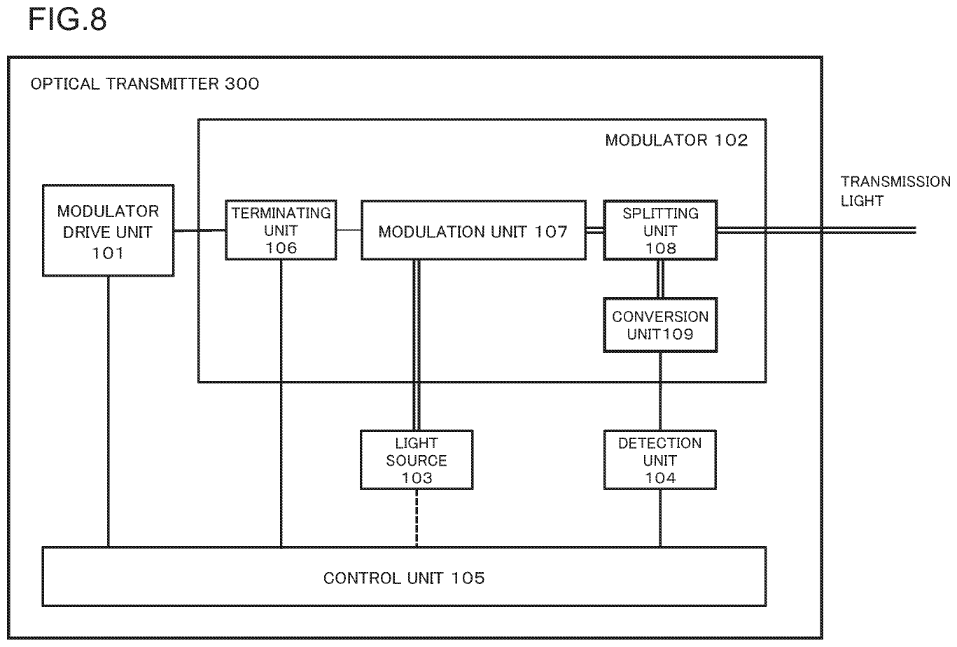

FIG. 8 is a block diagram illustrating a configuration example of an optical transmitter 300 of a fifth example embodiment. The optical transmitter 300 is a detailed configuration example of the optical transmitter 100 described in FIG. 1. In the optical transmitter 300, the light source 103 is a fixed wavelength laser or a wavelength-variable laser. The modulator 102 is a semiconductor optical modulator using indium phosphide or silicon as a material. The detection unit 104 is a low pass filter or a bandpass filter that blocks a frequency higher than a frequency f0 of the low-frequency signal that is outputted from the control unit 105 to the modulator drive unit 101 and the modulator 102.

The modulator 102 includes a terminating unit 106 serving as a terminating means that terminates the modulation signal, and a modulation unit 107 serving as an optical modulation means that modulates light, which is outputted from the light source 103, based on the terminated modulation signal. The modulator 102 further includes a splitting unit 108 serving as a splitting means that splits a part of the output of the modulation unit 107, and a conversion unit 109 serving as a conversion means that converts the split output light into an electrical signal and outputs the electrical signal to the detection unit 104. The terminating unit 106 further intensity-modulates the modulation signal by using the low-frequency signal inputted from the control unit 105. The intensity modulation on the modulation signal has been described in FIG. 3. The terminating unit 106 can intensity-modulate the modulation signal by changing a bias voltage of the modulation unit 107 with the low-frequency signal. The modulation unit 107 phase-modulates the output light of the light source 103 in response to the modulation signal terminated at the terminating unit, and outputs the modulated light. A known Mach-Zehnder type semiconductor optical modulator can be used as the modulation unit 107.

The splitting unit 108 splits a part of the output light of the modulation unit 107 and outputs the split output light to the conversion unit 109. The conversion unit 109 has an optical-electrical conversion function of converting the split output light into an electrical signal. The conversion unit 109 outputs the electrical signal having an intensity proportional to the output power of the modulation unit 107 to the detection unit 104. A directional coupler composed of a semiconductor optical waveguide can be used as the splitting unit 108. Furthermore, a photodiode can be used as the conversion unit 109. Note that the splitting unit 108 and the conversion unit 109 may be disposed outside the modulator 102.

The control unit 105 has a function of generating the low-frequency signal having the frequency f0, and outputs the low-frequency signal having the frequency f0 to the modulator drive unit 101 and the modulator 102. The frequency f0 of the low-frequency signal is lower than a frequency (modulation frequency) at which the continuous light outputted from the light source 103 is phase-modulated. The control unit 105 can adjust a phase difference of the low-frequency signal to be outputted to the modulator drive unit 101 and the modulator 102. The control unit 105 adjusts the phase and amplitude of the low-frequency signal to be outputted to the modulator drive unit 101 and the terminating unit 106 such that only a low-frequency component of one of the envelope on the positive side and the envelope on the negative side of the modulation signal is cancelled in the modulator 102. As a consequence, the envelope of the frequency f0 is generated only on the positive side or the negative side of the modulation signal. As described in FIG. 2 to FIG. 4 and FIG. 6, the shape of the envelope of the modulated light is determined by the low-frequency signal applied to the modulator drive unit 101 and the modulator 102.

In the optical transmitter 300 illustrated in FIG. 8, the modulator drive unit 101 amplitude-modulates the modulation signal for driving the modulator 102 by the low-frequency signal inputted from the control unit 105, and outputs the amplitude-modulated modulation signal to the terminating unit 106. The terminating unit 106 intensity-modulates the amplitude-modulated modulation signal by using by the low-frequency signal inputted from the control unit 105. Then, based on the terminated modulation signal, the modulation unit 107 phase-modulates the light inputted from the light source 103. The control unit 105 can receive the monitor signal outputted from the detection unit 104, and detect the transfer characteristics of the modulator 102 based on the component of the frequency f0 included in the monitor signal.

The optical transmitter 300 of the fifth example embodiment having such a configuration can also clarify the characteristics of the modulator having output asymmetry due to a nonlinear effect, similarly to the first to fourth example embodiments.

Moreover, as described in the second example embodiment, the control unit 105 may also set the driving conditions of the modulator 102 based on the monitor signal received from the detection unit 104. As a consequence, in the optical transmitter 300 of the fifth example embodiment, it is possible to optimize a driving signal by observing the characteristics of the modulator having output asymmetry due to a nonlinear effect, in such a way that it is possible to prevent the degradation of a signal quality.

Moreover, as described in the third example embodiment, the control unit 105 may also set the driving conditions of the modulator 102 by detecting transfer characteristics corresponding to each of the peaks P1 and P2 of the transfer characteristics.

Moreover, as described in the fourth example embodiment, the control unit 105 has a function of switching the wavelength or output power of the light source 103, and even when this switching is performed, the control unit 105 may detect the output characteristics of the modulator 102 after the switching and operate the modulator 102 in more preferable modulation conditions.

The control unit 105 may change the amplitude of the modulation signal to be inputted to the modulator 102 in a state in which the low-frequency signal is superimposed only on one of the envelope on the positive side and the envelope on the negative side, and check changes in the amplitude of a monitor signal at that time. With such a procedure, it is possible to know the transfer characteristics of the modulator 102 in more detail. As a consequence, for example, a driving voltage corresponding to the output power of the modulator 102 of each level at the time of multilevel amplitude modulation can be more preferably set in consideration of the nonlinearity of the modulator 102. The amplitude of the modulation signal may be controlled by an instruction of the control unit 105 to the modulator drive unit 101. Based on the transfer characteristics detected in this way, the control unit 105 can generate a predistortion signal capable of compensating for a space between levels of the multilevel amplitude modulation. When the predistortion signal generated in this way is used, since it is possible to equalize an inter-symbol interval of a modulated signal, an error rate of the output light of the modulator 102 is reduced, in such a way that high quality transmission becomes possible.

### Sixth Example Embodiment

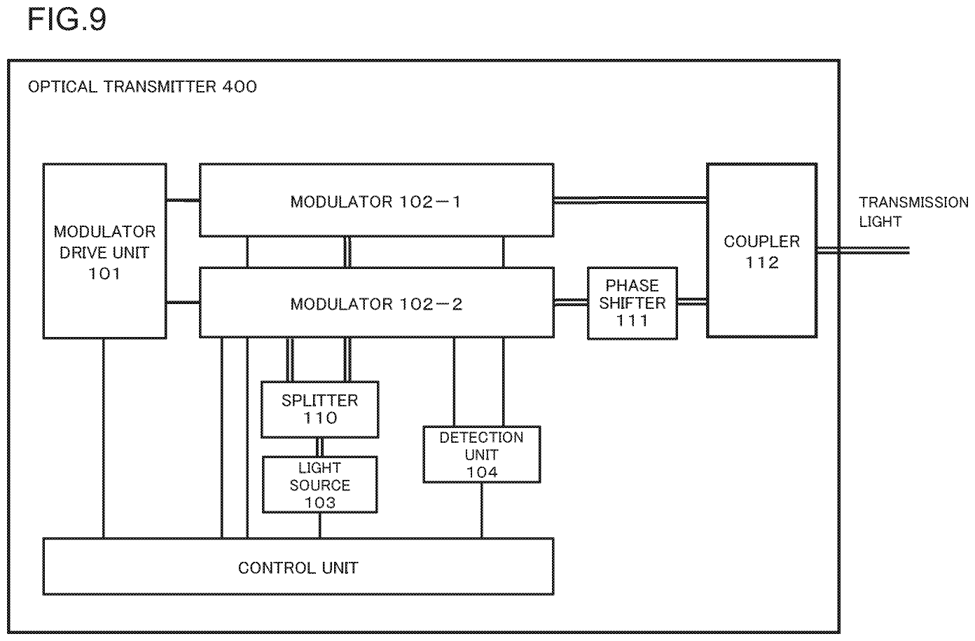

FIG. 9 is a block diagram illustrating a configuration example of an optical transmitter 400 of a sixth example embodiment. The optical transmitter 400 further includes two modulators 102-1 and 102-2, a splitter 110, a phase shifter 111, and a coupler 112. The modulators 102-1 and 102-2 are equal to the modulator 102 described in the above example embodiments.

The splitter 110 is a beam splitter that splits the output light of the light source 103. The splitter 110 splits the output light of the light source 103 and outputs the split output light to the modulators 102-1 and 102-2. The modulators 102-1 and 102-2 modulate each split light. The phase of the output light of the modulator 102-2 is adjusted by the phase shifter 111 such that a phase difference with the output light of the modulator 102-1 is π/2. The output light of the modulator 102-1 and the output light of the phase shifter 111 are coupled by the coupler 112 and are outputted as transmission light. As the coupler, a polarization beam combiner (PBC) can be used.

With such a configuration, the optical transmitter 400 can perform large capacity communication using quadrature phase shift keying (QPSK), in addition to the effects of the optical transmitters 100, 200, and 300 described in the first to fifth example embodiments. Furthermore, two optical transmitters 400 are prepared and respective output lights are polarization-combined, in such a way that dual capacity transmission (dual polarization-QPSK) also becomes possible.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

Furthermore, the configurations described in the respective example embodiments are not always exclusive to each other. The operation and effect of the present invention may also be implemented by a combination of all or some of the aforementioned example embodiments.

Furthermore, the functions and procedures described in each example embodiment may also be implemented by executing a program by a central processing unit (CPU) included in the control unit 105. The program is recorded on a tangible and non-transitory recording medium. A semiconductor memory included in the control unit 105 is used as the recording medium; however, the present invention is not limited thereto.

This application is based upon and claims the benefit of priority from Japanese patent application No. 2017-063183, filed on Mar. 28, 2017, the disclosure of which is incorporated herein in its entirety by reference.

### REFERENCE SIGNS LIST

100, 200, 300, 400 Optical transmitter
101 Modulator drive unit
102, 102-1, 102-2 Modulator
103 Light source
104 Detection unit
105 Control unit
106 Terminating unit
107 Modulation unit
108 Splitting unit
109 Conversion unit
110 Splitter
111 Phase shifter
112 Coupler

What is claimed is:

1. An optical transmitter comprising:
a light source configured to output light of a predetermined wavelength;
a modulator configured to modulate the light outputted from the light source by a modulation signal;
a modulator driver configured to output the modulation signal to the modulator;
a controller configured to output a low-frequency signal to the modulator and the modulator driver, amplitude-modulate the modulation signal with the low-frequency signal, intensity-modulate the amplitude-modulated modulation signal with the low-frequency signal, and receive a monitor signal including a component of the low-frequency signal; and
a detector configured to extract a low-frequency component of an optical signal outputted from the modulator and output the extracted low-frequency component as the monitor signal.

2. The optical transmitter according to claim 1, wherein
the controller performs the amplitude modulation and the intensity modulation such that the low-frequency signal is superimposed only on one of an envelope on a positive side and an envelope on a negative side of the amplitude-modulated and intensity-modulated modulation signal.

3. The optical transmitter according to claim 1, wherein
the controller
performs first amplitude modulation and intensity modulation such that the low-frequency component is superimposed only on the envelope on the positive side of the amplitude-modulated and intensity-modulated modulation signal, and
performs second amplitude modulation and intensity modulation such that the low-frequency component is superimposed only on the envelope on the negative side of the amplitude-modulated and intensity-modulated modulation signal.

4. The optical transmitter according to claim 1, wherein
the controller detects transfer characteristics of the modulator, based on the monitor signal.

5. The optical transmitter according to claim 4, wherein
the controller has a function of switching at least one of a wavelength and output power of the light source, and detects the transfer characteristics of the modulator with execution of the switching.

6. The optical transmitter according to claim 4, wherein
the controller sets driving conditions of the modulator, based on the detected transfer characteristics.

7. The optical transmitter according to claim 6, wherein
the controller sets the driving conditions, based on at least one of a bias voltage applied to the modulator, a driving amplitude of the modulation signal, and predistortion of the modulation signal.

8. The optical transmitter according to claim 1, wherein the modulator comprises:
a terminator configured to terminate the modulation signal;
an optical modulator configured to modulate the light outputted from the light source, based on the terminated modulation signal;
a splitter configured to split a part of output of the optical modulator; and
a converter configured to convert the split output light into an electrical signal and output the electrical signal to the detector.

9. An optical transmission method comprising:
outputting light of a predetermined wavelength;
modulating, by a modulator, the light outputted from the light source by a modulation signal;
outputting the modulation signal to the modulator;
amplitude-modulating the modulation signal with the low-frequency signal;
intensity-modulating the amplitude-modulated modulation signal with the low-frequency signal;
outputting, as a monitor signal, a low-frequency component of an optical signal outputted from the modulator; and
detecting transfer characteristics of the modulator, based on the monitor signal.

10. The optical transmission method according to claim 9, wherein
the amplitude modulation and the intensity modulation are performed such that the low-frequency signal is superimposed only on one of an envelope on a positive side and an envelope on a negative side of the amplitude-modulated and intensity-modulated modulation signal.

11. The optical transmitter according to claim 2, wherein
the controller
performs first amplitude modulation and intensity modulation such that the low-frequency component is superimposed only on the envelope on the positive side of the amplitude-modulated and intensity-modulated modulation signal, and
performs second amplitude modulation and intensity modulation such that the low-frequency component is superimposed only on the envelope on the negative side of the amplitude-modulated and intensity-modulated modulation signal.

12. The optical transmitter according to claim 2, wherein
the controller detects transfer characteristics of the modulator, based on the monitor signal.

13. The optical transmitter according to claim 3, wherein
the controller detects transfer characteristics of the modulator, based on the monitor signal.

14. The optical transmitter according to claim 11, wherein
the controller detects transfer characteristics of the modulator, based on the monitor signal.

15. The optical transmitter according to claim 12, wherein
the controller has a function of switching at least one of a wavelength and output power of the light source, and detects the transfer characteristics of the modulator with execution of the switching.

16. The optical transmitter according to claim 13, wherein
the controller has a function of switching at least one of a wavelength and output power of the light source, and detects the transfer characteristics of the modulator with execution of the switching.

17. The optical transmitter according to claim 2, wherein the modulator comprises:
a terminator configured to terminate the modulation signal;
an optical modulator configured to modulate the light outputted from the light source, based on the terminated modulation signal;
a splitter configured to split a part of output of the optical modulator; and
a converter configured to convert the split output light into an electrical signal and outputting the electrical signal to the detector.

18. The optical transmitter according to claim 3, wherein the modulator comprises:
a terminator configured to terminate the modulation signal;
an optical modulator configured to modulate the light outputted from the light source, based on the terminated modulation signal;
a splitter configured to split a part of output of the optical modulator; and
a converter configured to convert the split output light into an electrical signal and outputting the electrical signal to the detector.

19. The optical transmitter according to claim 4, wherein the modulator comprises:
a terminator configured to terminate the modulation signal;
an optical modulator configured to modulate the light outputted from the light source, based on the terminated modulation signal;
a splitter configured to split a part of output of the optical modulator; and
a converter configured to convert the split output light into an electrical signal and outputting the electrical signal to the detector.

20. The optical transmitter according to claim 19, wherein
the controller has a function of switching at least one of a wavelength and output power of the light source, and detects the transfer characteristics of the modulator with execution of the switching.
